(19) United States
(12) Patent Application Publication
(10) Pub. No.: US 2009/0095114 A1
(43) Pub. Date: Apr. 16, 2009

(54) Steering column assembly having a rotating drive cable device

(76) Inventors: Jason R. Ridgway, Bay City, MI (US); Terry L. McDonald, Merrill, MI (US); Stephen J. Reider, Frankenmuth, MI (US)

Correspondence Address: HOWARD & HOWARD ATTORNEYS PLLC, 450 West Fourth Street, Royal Oak, MI, 48067, US

(21) Appl. No.: 11/974,626

(22) Filed: Oct. 15, 2007

(51) Int. Cl. B62D 1/18

(52) U.S. Cl. 74/493

(57) ABSTRACT

A rotating cable device preferably for use in a steering column assembly couples a drive member to a driven member of the assembly for rotation and without any lost motion or release of unwanted absorbed energy, which could potentially create inefficiencies in operation and undesirable noise. A rigid sheath of the device extends along a non-linear centerline and a resilient tube preferably extends through the sheath. A flexible cable of the device extends through the tube and couples between the members for rotation. The cable device enables versatility in the arrangement and orientation of the drive and driven members in a variety of different steering column and transmission shift mount applications for vehicles.

### TECHNICAL FIELD

The present invention relates to a steering column assembly, and more specifically to a steering column assembly having a rotating drive cable device.

### BACKGROUND OF THE INVENTION

Known drive cable devices typically consist of a flexible sheath and a drive cable. The sheath is designed to support the drive cable with both the sheath and the cable being flexible to allow routing in non-linear geometries. The flexibility of the sheath, or bending stiffness, depends on the amount of cable flexure required to allow routing in the non-linear geometry and the ability to resist normal forces of the cable as torques is applied. This type of drive cable device configuration induces high forces into the drive and driven members and allows significant energy to be stored in the drive cable device. Unfortunately, when the applied torque to the cable is reversed, the stored energy in the cable is released and thus induces a “clunk” into the system. Because such cable devices store energy, they create unwanted noise into the applied assembly.

Typically, the rotating rotor of the electric motor attaches directly to the mechanism it generally automates or drives. Such rigid connections limit placement of the motor in the column assembly and may require complicated and expensive couplings such as worm gears. In general terms, the versatility in the packaging of a steering column is limited and often requires numerous and a variety of parts that contribute toward expensive manufacturing costs. Unfortunately, a degree of motion is lost when a torque is applied to known rotating and sheathed cables making such cables less than ideal for the applications described above.

### SUMMARY OF THE INVENTION

A rotating cable device preferably for use in a steering column assembly couples a drive member to a driven member of the assembly for rotation and without any lost motion or release of unwanted absorbed energy, which could potentially create inefficiencies in operation and undesirable noise. A rigid sheath of the device extends along a non-linear centerline and a resilient tube preferably extends through the sheath. A flexible cable of the device extends through the tube and couples between the members for rotation. The cable device enables versatility in the arrangement and orientation of the drive and driven members in a variety of different steering column and transmission shift mount applications for vehicles.

Preferably, the drive member is an electric motor and the rotor of the motor couples directly to the cable of the cable device. Use of the device increase versatility in the placement of the motor and reduces or eliminates the need for rigid connections and complicated and expensive couplings such as worm gears. In general terms, the versatility in the packaging of a steering column is enhanced and the variety of necessary parts is reduced. Operation of the steering column assembly is improved and unwanted noise during operation is reduced.

Other objects, features and advantages of the present invention include a steering column assembly that is compact, robust, simple and inexpensive to manufacture, and requires little or no maintenance and in service has a long and useful life.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded perspective view of a rotating drive cable device embodying the present invention;

FIG. 2 is a cross section of the rotating drive cable device;

FIG. 3 is a perspective view of an end portion of a cable of the drive cable device;

FIG. 4 is a perspective view of a steering column assembly having the drive cable device;

FIG. 5 is a perspective view of a second embodiment of a steering column assembly having the drive cable device; and

FIG. 6 is a perspective view of a third embodiment of a steering column assembly having the drive cable device.

### DESCRIPTION OF THE PREFERRED EMBODIMENT

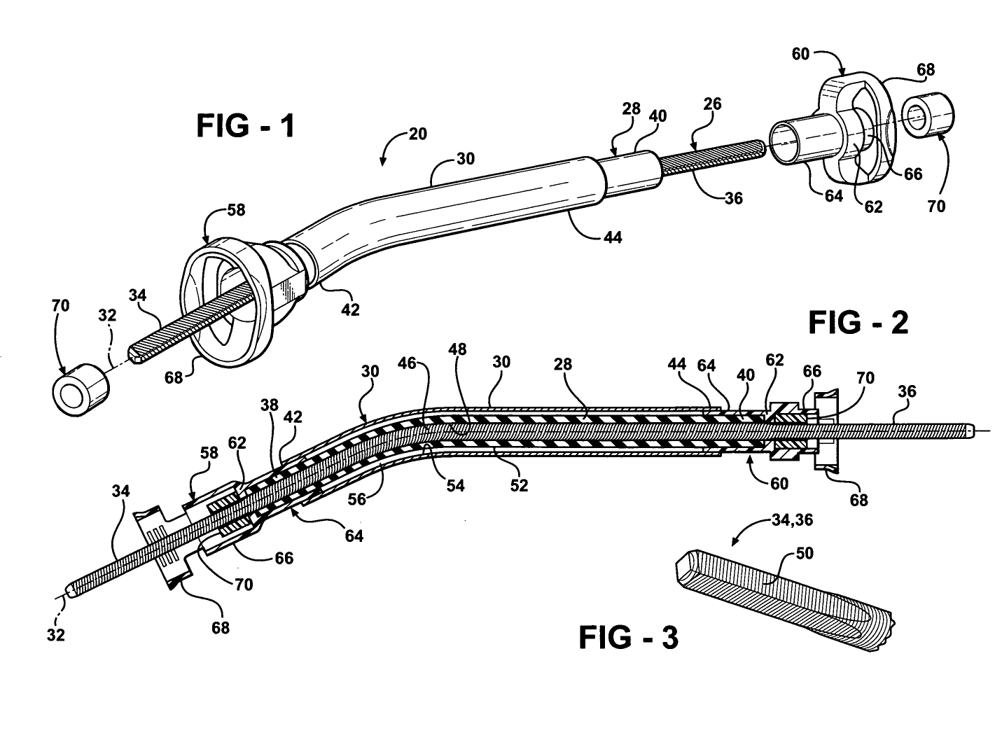

Referring to FIGS. 1-4, a rotating cable device 20 embodying the present invention preferably couples a drive member 22 to a driven member 24 for rotational movement. The cable device 20 has a flexible cable 26, a flexible tube 28 and a rigid sheath 30 all co-extending concentrically along a non-linear centerline 32. Preferably, the cable 26 is longer than the tube 28 which is longer than the sheath 30. Hence, opposite end portions 34, 36 of the cable 26 project axially beyond opposite end segments 38, 40 of the tube 28 which project axially beyond opposite end sections 42, 44 of the sheath 30.

The cable 26 is preferably made of steel having spun strands for providing strength and flexibility. A mid portion 46 of the cable 26 is axially aligned or centered to the tube 28 and has a longitudinal length that is slightly longer than a longitudinal length of the tube 28. Because the cable 26 rotates with respect to the tube 28, the mid portion 46 of the tube 28 is fitted loosely through the tube 28. To enhance flexibility and reduce rotational friction between the tube 28 and the cable 26, the mid portion 46 is substantially cylindrical and opposes a cylindrical inner surface 48 of the tube 28. As best shown in FIG. 3, the end portions 34, 36 of the cable 26 are preferably non-cylindrical and have at least one flat or circumferentially keyed side 50 (e.g. a square cross sectional profile) for rotational engagement to the drive and driven members 22, 24. This non-cylindrical or square profile may be machined pressed into the otherwise cylindrical cable during manufacturing.

The tube 28 is preferably made of a resilient and flexible rubber-like material for in-part reducing system noise or clunking of the cable 26. For ease of assembly, the tube 28 loosely fits through the sheath 30 so that a cylindrical outer surface 52 of the tube 28 opposes a cylindrical inner face 54 of the sheath 30. Preferably, the outer surface 52 and the inner face 54 radially define an annular cavity 56 for press fitting of opposite end connectors 58, 60 of the device 20 therein.

The end connectors 58, 60 are preferably made of injection molded plastic and function to snap fit the device 20 to the respective drive and driven members 22, 24 while generally stabilizing the cable 26 for smooth rotational operation. Each connector 58, 60 preferably has an annular base 62, a tubular sleeve 64 projecting axially inward from the base 62, a tubular collar 66 projecting axially outward from the base 62 and a snap fit fastener or cage 68 for engagement to the respective drive and driven members 22, 24.

During assembly of the device 20, the end segments 38, 40 of the tube 28 are abutted axially against the annular bases 62 of the respective connectors 58, 60. The resiliency of the tube 28 exerts a force, directed radially outward, against the sleeves 64 for a tight fit. Because the sleeves 64 are axially longer than the respective end segments 38, 40 of the tube 28, a distal portion of the sleeves 64 is located in the cavity 56 and fitted snugly and radially between the inner face 54 of the sheath 30 at the end sections 42, 44 and the outer surface 52 of the tube 28. One skilled in the art would now know that the end sections 42, 44 of the sheath 30 may be flared radially outward to assist in the fitted axial receipt of the sleeves 64. Moreover, if the end sections 42, 44 are flared, the annular cavity 56 may only be present or defined at the end sections 42, 44, and the remaining longitudinal length or mid portion of the sheath 30 may be in close contact generally with the mid portion of the tube 28.

With end segments 38, 40 of the tube 28 inserted fully into the sleeves 64, a bushing 70 of each connector 58, 60 slides axially over the end portions 34, 36 of the cable 26 and until the bushings 70 abut the bases 62 of the respective connectors 58, 60. When the bushings 70 are abutted or fully installed, they are axially aligned to and located radially inward from the collars 66 of the respective connectors 58, 60. Preferably, the bushings 70 tightly fit to the mid portion 46 of the cable 26 for maintaining axial alignment of the cable 26 with respect to the tube 28 of the sheath 30. As best shown in FIG. 2, the bushing 70 in connector 60 may be in a rotational contact with the collar 66. Preferably, the collars 66 are made of a plastic or plastic-like material with friction reducing characteristics.

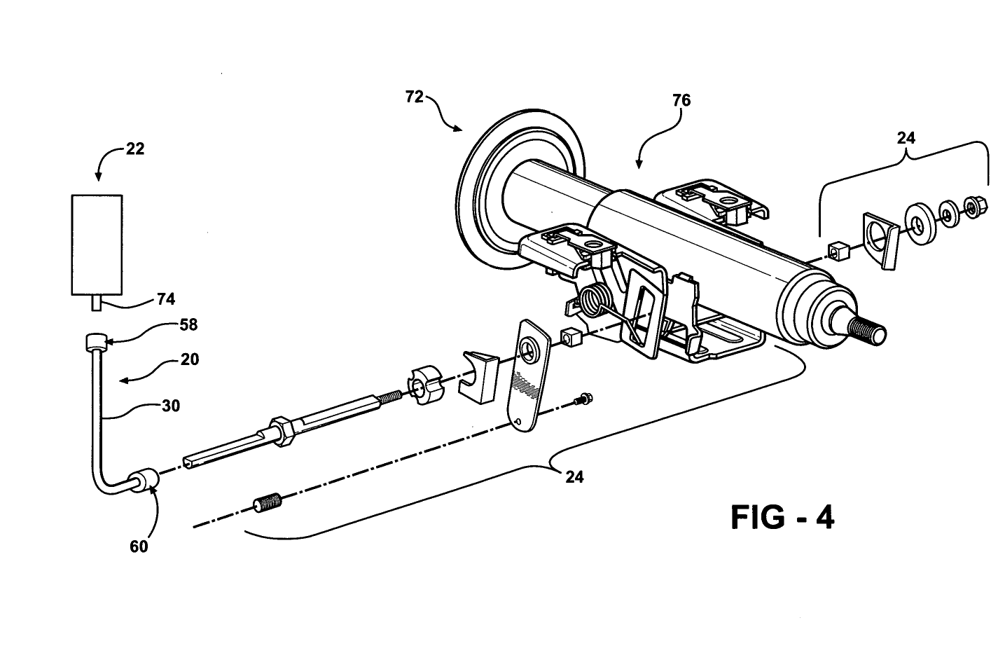

Referring to FIG. 4, the rotating cable device 20, drive member 22 and driven member 24 are preferably suited for (i.e. as part of) a steering column assembly 72. The drive member 22 is preferably an electric motor having a rotating rotor 74 contoured to connect to the end portion 34 of the cable 26. The fastener 68 preferably snap fits to the same stationary structure that supports the motor 22. The driven member 24 may be an adjustment mechanism of the assembly 72 that functions to telescopically and/or tilt adjust a steering column 76 of the assembly 72. This automated adjustment may be limited to locking the steering column 76 in-place once the desired position is established or may function to both position the column 76 and generally lock it in the desired position. One particular steering column application or adjustment mechanism 24 is taught in U.S. Pat. No. 7,055,860, and is incorporated herein by reference in its entirety. The novel application of the cable device 20 enables versatile and remote placement of the motor 22 in any variety of positions.

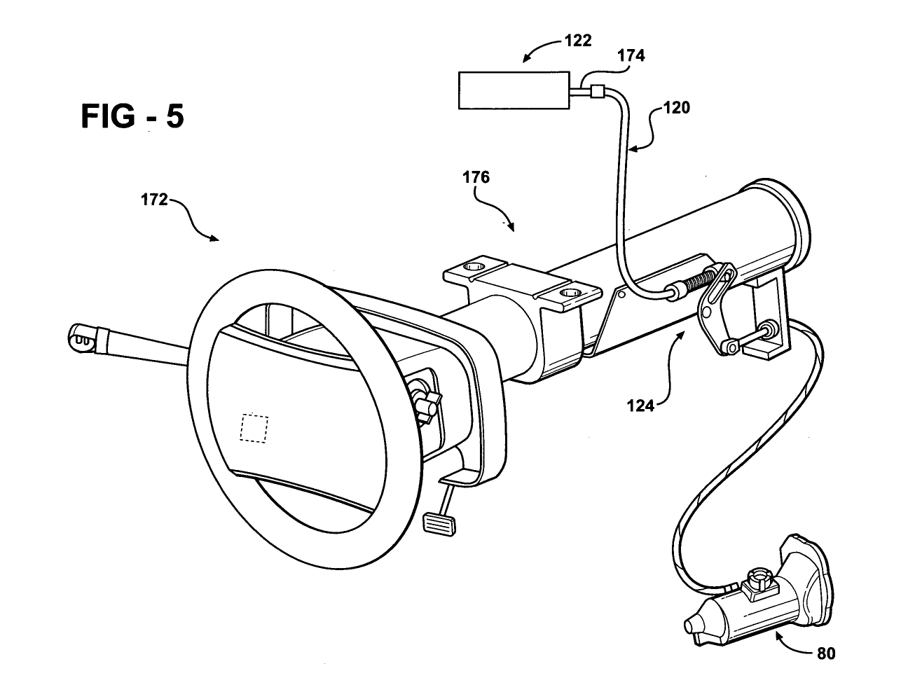

Referring to FIG. 5, a second embodiment of a steering column assembly 172 is illustrated wherein like elements to the first embodiment have the same identifying numerals except with the summed addition of one hundred. In the second embodiment, the assembly 172 has a rotating cable device 120, a drive member 122 and a driven member 124. The drive member 122 is preferably an electric motor having a rotating rotor 174 contoured to connect to an end portion 134 of a rotating cable 126. The driven member 124 is generally a transmission shifter mechanism that controls a transmission 80 of a vehicle. Such an application is taught in U.S. Pat. No. 7,137,499 and is incorporated herein by reference in its entirety. Other applications for the rotating cable device 120 may include a one-touch steering column, a power adjustable steering column, and electric transmission shifter and an electric steering column lock.

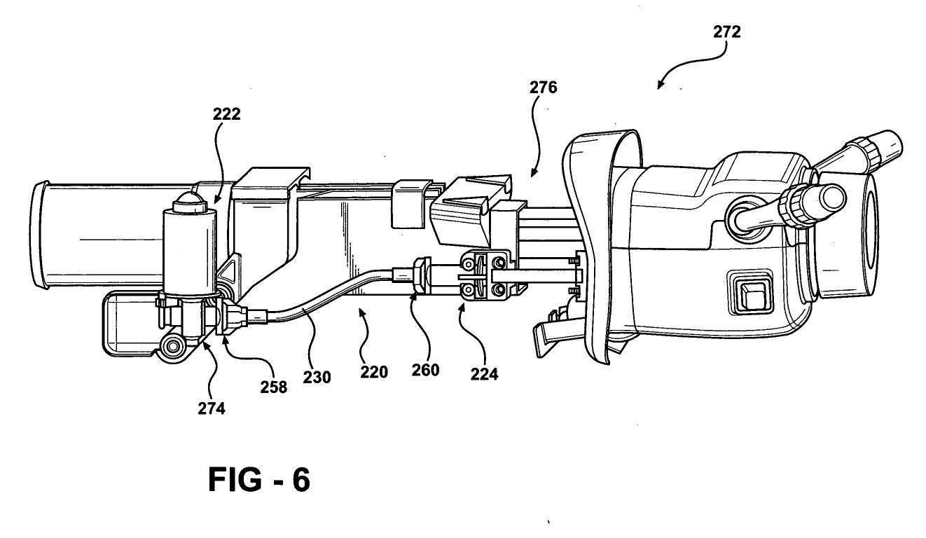

Referring to FIG. 6, a third embodiment of a steering column assembly 272 is illustrated wherein like elements to the first embodiment have the same identifying numerals except with the summed addition of two hundred. The steering column assembly 272 is commonly referred to as a power adjustable steering column. In the third embodiment, the assembly 272 has a rotating cable device 220, a drive member 222 and a driven member 224. The drive member 222 is preferably an electric motor having a rotating rotor 274 contoured to connect to an end portion 234 of a rotating cable 226. As discussed above, the driven member 224 may be an adjustment mechanism of the assembly 272 that functions to telescopically and/or tilt adjust a steering column 276 of the assembly 272.

While the forms of the invention herein disclosed constitute presently preferred embodiments, many others are possible. It is not intended herein to mention all the possible equivalent forms or ramifications of the invention. It is understood that terms used herein are merely descriptive, rather than limiting, and that various changes may be made without departing from the spirit or scope of the invention.

What is claimed is:

1. A steering column assembly comprising:
at least one of an adjustment mechanism for positioning a steering wheel and a transmission shifter mechanism;
an electric motor for driving said adjustment mechanism or said transmission shifter mechanism; and
a rotating cable device coupled between said motor and said one of said adjustment mechanism and said shifter mechanism with said rotating cable device having a tubular outer sheath extending longitudinally along a centerline, and a cable extending longitudinally through said sheath for rotation about said centerline.

2. The steering column assembly set forth in claim 1 wherein said sheath is rigid and said cable is flexible.

3. The steering column assembly set forth in claim 2 wherein said sheath is not longitudinally linear.

4. The steering column assembly set forth in claim 3 further comprising:
said sheath having a first end portion and an opposite second end portion; and
a resiliently flexible tube located radially between said sheath and said cable.

5. The steering column assembly set forth in claim 4 wherein said tube projects axially beyond said first and second end portions.

6. The steering column assembly set forth in claim 5 further comprising a first connector press fitted into said first end portion and a second connector press fitted into said second end portion.

7. The steering column assembly set forth in claim 6 further comprising first and second bushing press fitted into respective first and second connectors.

8. A steering column assembly comprising:
a drive member;
a driven member; and
a rotating cable device coupled between said drive and driven members, said rotating cable device having a rigid sheath extending longitudinally along a centerline, a resilient tube extending longitudinally through said sheath, and a cable extending longitudinally through said tube for rotation about said centerline.

9. The steering column assembly set forth in claim 8 wherein said drive member is an electric motor having a rotor coupled to said rotating cable device.

10. The steering column assembly set forth in claim 8 wherein said driven member is a steering column adjustment mechanism.

11. The steering column assembly set forth in claim 8 wherein said driven member is a transmission shifter mechanism.

12. A rotating cable device comprising:
a rigid sheath extending along a centerline;
a flexible tube extending along said centerline and through said sheath with said tube and said sheath radially defining an annular cavity;
a flexible cable extending along said centerline and through said tube for rotation about said centerline; and
a first end connector press fitted axially into said cavity with said cable extending through said connector.

13. The rotating cable device set forth in claim 12 further comprising:
said first connector having a collar; and
a first bushing located concentrically to said centerline and radially between said cable and said collar.

14. The rotating cable device set forth in claim 12 wherein said centerline is non-linear.

15. The rotating cable device set forth in claim 13 wherein said centerline is non-linear.

16. The rotating cable device set forth in claim 12 wherein said cable has a cylindrical mid portion axially aligned to said tube and a non-cylindrical first end portion.

17. The rotating cable device set forth in claim 13 wherein said cable has a cylindrical mid portion axially aligned to said tube and said bushing and a non-cylindrical first end portion projecting axially outward from said bushing and said collar.

18. The rotating cable device set forth in claim 13 wherein said first connector has a cylindrical sleeve extending axially inward from said collar and press fitted radially between said sheath and said tube.

19. The rotating cable device set forth in claim 18 wherein said first connector has a snap-fit fastener.

20. The rotating cable device set forth in claim 12 wherein said sheath is constructed and arranged to deform plastically.
